(19) United States
(12) Patent Application Publication
(10) Pub. No.: US 2008/0249876 A1
(43) Pub. Date: Oct. 9, 2008

(54) METHOD AND SYSTEM USING DISTRIBUTIONS FOR MAKING AND OPTIMIZING OFFER SELECTIONS

(76) Inventors: JAMES RICE, Redwood City, CA (US); SIMON HANDLEY, Palo Alto, CA (US); HARI MENON, Fremont, CA (US); PRADEEP JAVANGULA, San Jose, CA (US)

Correspondence Address: GLENN PATENT GROUP, 3475 EDISON WAY, SUITE L, MENLO PARK, CA, 94025, US

(21) Appl. No.: 12/099,003

(22) Filed: Apr. 7, 2008

Related U.S. Application Data
(60) Provisional application No. 60/910,612, filed on Apr. 6, 2007.

(51) Int. Cl. G06Q 30/00

(52) U.S. Cl. 705/14

(57) ABSTRACT

A method and system for making and optimizing offer selections targeted to particular recipients or groups improves selection quality by combining and aggregating quantitative and qualitative data to capture recipient needs and provider expectations and intentions. Offer descriptions are first received. Distribution variables for application to offer descriptions and recipients are then selected. Distributions are then assigned to offer descriptions, and distributions appropriate to the recipient are determined and assigned to the recipient. Distributions can incorporate demographic, psychographic and behavioral variables. Offer description distributions and recipient distributions are combined for each offer description, resulting in a ranking for each offer description. Offer descriptions are automatically selected based on the rankings, using, for example, simple ordering or roulette wheel selection. Offer descriptions are instantiated as offers, and finally offers are output to the recipient.

### CROSS REFERENCE TO RELATED APPLICATION

This Application claims benefit of U.S. provisional patent application Ser. No. 60/910,612, filed Apr. 6, 2007, the entirety of which is incorporated herein by this reference thereto.

### BACKGROUND OF THE INVENTION

1. Field of the Invention

The invention generally relates to systems and methods for targeting offers in both online and offline environments. More particularly, the invention relates to a method and system for selecting offers in general and for improving offer selections using a combination and aggregation of both quantitative and qualitative data so as to capture both the needs of the recipients of the selections and the expectations and intentions of the providers.

2. Background Information

Many activities require the selection of a set of offers from a population of available offers to fulfill the needs of a recipient. In the computing domain, this need to make selections and distribute those selections to a set of recipients is very evident in the field of advertising, wherein many offers are generally available and selections must be made so as to occupy the available advertising real estate. Making such offer selections becomes increasingly challenging as the number of offers increases relative to the number of available advertising spots. One way of leveraging the limited amount of advertising on a web page, for example, is by targeting the offer selections to prospective recipients. However, if it is a priority to make selections that are appropriate to a particular user community, the complexity of the task of making offers is compounded.

As e-commerce has proliferated, methods of advertising and merchandising suited to e-commerce business models have evolved. The first banner ads appeared on Internet sites in 1994. Initially, these banner ads were statically assigned, wherein the advertisements in a page did not generally change unless a site administrator changed them. Later, ad servers allowed the provision of banner ads that rotated automatically.

Targeting, which includes contextual targeting and behavioral targeting methodologies, allowed advertisers to key the ad displayed to textual content on the page or to the visitor profile based on past visits to other web sites. Machine learning approaches made it possible to adapt advertising and merchandising to the customer in real time.

Collaborative filtering techniques make it possible to enrich a user profile with attributes extracted from profiles of other similar users. Additionally, collaborative filtering has enabled cross-merchandising, such as cross-selling and up-selling, in the online environment.

It has also become possible further to personalize offer selections by including geographic and psychographic variables in a user profile, such as the approximate location of the user by using the user's IP address, or the user reaction to previous promotions. Often, demographic variables can be inferred from a user's behavior. For example, it can be reliably inferred that a user who logs a high number of visits to technology web sites and to web sites for men's fitness magazines is a male of a certain age group.

Nevertheless, the development of specific marketing and targeting strategies in the online environment remains extremely labor-intensive and time-consuming. In fact, the process becomes intractable when the number of offers, advertisers, publishers or user demographic or psychographic segments is very large.

### SUMMARY

A method and system for making and optimizing offer selections targeted to particular recipients or groups improves selection quality by combining and aggregating quantitative and qualitative data to capture recipient needs and provider expectations and intentions. Quantitative and qualitative data concerning recipients and offers are combined and aggregated to capture both the needs of recipients and expectations and intentions of providers. Offer descriptions are first received. Distribution variables for application to offer descriptions and recipients are then selected. Distributions are then assigned to offer descriptions and distributions appropriate to the recipient are determined and assigned to the recipient. Distributions can incorporate demographic, psychographic and behavioral variables. Offer description distributions and recipient distributions are combined for each offer description, resulting in a ranking for each offer description. Offer descriptions are automatically selected for display based on the rankings, using, for example, simple ordering or roulette selection. Offer descriptions are instantiated as offers, and finally offers are output to the recipient.

Terminology

The following description uses a number of terms that, within the present context, are understood to have a meaning particular to the context. Such terms include:

Offer: Within the present context, an offer is a general term used to denote the exposure, to a recipient, of a specific presentation of something that a provider wishes to show to said recipient. In the context of advertising, an offer might be a specific banner advertisement shown to an individual user, possibly tailored to that particular user. In the field of politics, an offer might be a particular direct-mail letter sent to a member of the electorate, possibly tailored to the individual or the demographic segment to which the recipient belongs.

Offer description: Within the present context, an offer description is the representation provided by the provider to the present invention for it to instantiate as offers to recipients. In its simplest form, an offer description might be a banner graphic creative, which would be presented as-is to the recipients. An offer description might also be an entry in a product catalog, which when instantiated would be presented to a recipient as a picture of a product, annotated with, for example, price, brand and description. An offer description might also be a parameterized letter, which when instantiated by the present invention would turn into a letter apparently tailored to the recipient. For brevity, and when the context is unambiguous, we will sometimes refer to offer descriptions simply as “offers.”

Provider: Within the present context, a provider is either a retailer or a manufacturer or another party that provides offer descriptions (e.g., goods and/or services) to the present invention. In the following description, providers may be alternately referred to as “advertisers,” though advertisers are only a subset of all possible providers.

Publisher: Within the present context, a publisher is a party who makes a distribution channel and real estate available to a provider, e.g. for advertising. The publisher is typically an owner or sponsor of a web site or similar online venue. The publisher publishes the provider's offers. In some applications of the present invention, the publisher may be the postal mail service, in which case the distribution channel is the mail service, and the real estate is the recipient's mail box.

Recipient: Within the present context, a recipient is the recipient of or the party to whom the offer is directed. Typically, the recipient is an end user or a web site visitor-a prospective customer for the provider.

Product: Within the present context, a product could be any one of a wide variety of goods, for example, consumer electronics, computers, apparel, shoes, home furnishings, appliances, house and kitchenware, garden furnishings and tools, jewelry, watches, books, movies, music, video games, software, arts and crafts supplies, automobiles, real estate, baby accessories, toys and non-electronic games, food and wine, pets, pet accessories, beauty products, health products, optics, musical instruments, and the like.

Service: Within the present context, a service could be any one of a wide variety of services, for example, financial services, education, dating services, medical treatments, health and nutrition services, home maintenance, renovation and restoration, digitally distributed entertainment, subscription software, travel, rental cars, movie tickets, sports tickets, live theater tickets, business franchise services, and the like.

Media Content: Within the present context, media content could be something like news, television show information, reviews, previews, movie information, sports information and content, and the like.

Classified Advertisement: Within the present context, classified advertisements could be, for example, career listings, real estate rentals and leases, personals, or the like.

Broadcast Media: Within the present context, broadcast media could be, for example, broadcast TV, cable TV, satellite TV, broadcast radio, satellite radio, magazines, newspapers, other print media, and the like.

Out of Home Advertising: Within the present context, out of home advertising could be, for example, billboards, hotel lobbies, tradeshows, newsstands, public transportation stops, elevator displays, on- and in-taxi, public transport vehicles, t-shirts or the like.

### BRIEF DESCRIPTION OF THE DRAWINGS

FIG. 1 provides a diagram of a machine in the exemplary form of a computer system within which a set of instructions, for causing the machine to perform any one of the methodologies discussed herein below, may be executed;

FIG. 2 shows a chart of a quantitative age distribution;

FIG. 3 shows a chart of a qualitative age distribution;

FIG. 4 shows a flow diagram of a method for automatically targeting offer selection; and

FIG. 5 shows a diagram of a roulette wheel selection mechanism.

### DETAILED DESCRIPTION

A method and system for making and optimizing offer selections targeted to particular recipients or groups improves selection quality by combining and aggregating quantitative and qualitative data to capture both a recipient's needs and a provider's expectations and intentions. Quantitative and qualitative data concerning recipients and offers are combined and aggregated to capture both the needs of recipients and expectations and intentions of providers. Offer descriptions are first received. Distribution variables for application to offer descriptions and recipients are then selected. Distributions are then assigned to offer descriptions and distributions appropriate to the recipient are determined and assigned to the recipient. Distributions can incorporate demographic, psychographic or behavioral variables. Offer description distributions and recipient distributions are combined for each offer description, resulting in a ranking for each offer description. Offer descriptions are automatically selected for display based on the rankings, using, for example, simple ordering or roulette wheel selection. Offer descriptions are instantiated as offers, and finally offers are output to the recipient.

The following description is directed to a method and system that automatically targets suitable offer selections to specific recipients or groups of recipients. An advertiser typically wishes to present offer descriptions such as product offers to a potential buying public. In general, the advertiser does not control or own the means of distribution of these advertisements. The real estate on which advertisements is displayed, whether that real estate be roadside billboards or sections of pages on web sites, is typically owned by a third party. These third parties, which we refer to as “publishers” in the context of web site advertising, generally have their own desire to maximize revenue from the use of the real estate that they own. Both the advertiser and the publisher have brand images to protect, and target audiences that they consider appropriate. Because the number of advertisers is very large, the number of offers they might wish to offer is very large, and the number of publishers and publisher web pages are both very large, it is important to make good selections to use the advertisers' resources to the best effect so as to maximize sales, and also to derive the most possible benefit from the available publisher real estate. We note that although we have been discussing the specific case of online advertising here, this is just a specific example of a broad class of problems to which the present invention is applicable. For example, if the offer descriptions are mail templates then the offers instantiated by the present invention might be specifically tailored, targeted letters on paper, and distributed by conventional, physical mail.

This system and method herein described tackle this problem of meeting the needs of both the advertiser and the publisher simultaneously, taking into account numerous different criteria that have previously been impossible to combine. It is always possible for an advertiser and a publisher to cooperate closely on a marketing campaign and build a specific marketing and targeting strategy. This process is, however, extremely labor intensive and is intractable if the number of offers, advertisers, publishers, or user demographic or psychographic segments is very large. The system herein described enables a process that, once configured, allows the system automatically to target suitable offer selections to recipients.

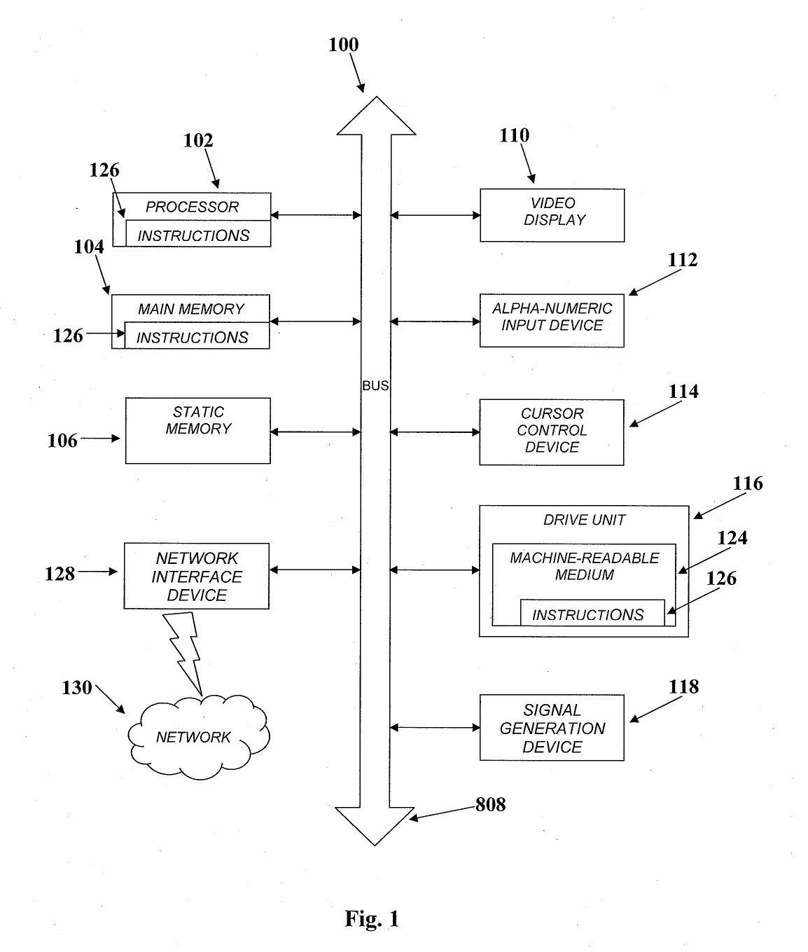

Referring now to FIG. 1, shown is a diagrammatic representation of a machine in the exemplary form of a computer system 100 within which a set of instructions for causing the machine to perform any one of the methodologies discussed herein below may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 100 includes a processor 102, a main memory 104 and a static memory 106, which communicate with each other via a bus 108. The computer system 100 may further include a display unit 110, for example, a liquid crystal display (LCD) or a cathode ray tube (CRT). The computer system 100 also includes an alphanumeric input device 112, for example, a keyboard; a cursor control device 114, for example, a mouse; a disk drive unit 116, a signal generation device 118, for example, a speaker, and a network interface device 128.

The disk drive unit 116 includes a machine-readable medium 124 on which is stored a set of executable instructions, i.e. software, 126 embodying any one, or all, of the methodologies described herein below. The software 126 is also shown to reside, completely or at least partially, within the main memory 104 and/or within the processor 102. The software 126 may further be transmitted or received over a network 130 by means of a network interface device 128.

In contrast to the system 100 discussed above, a different embodiment of the invention uses logic circuitry instead of computer-executed instructions to implement processing offers. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large scale integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the Central Processing Unit of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

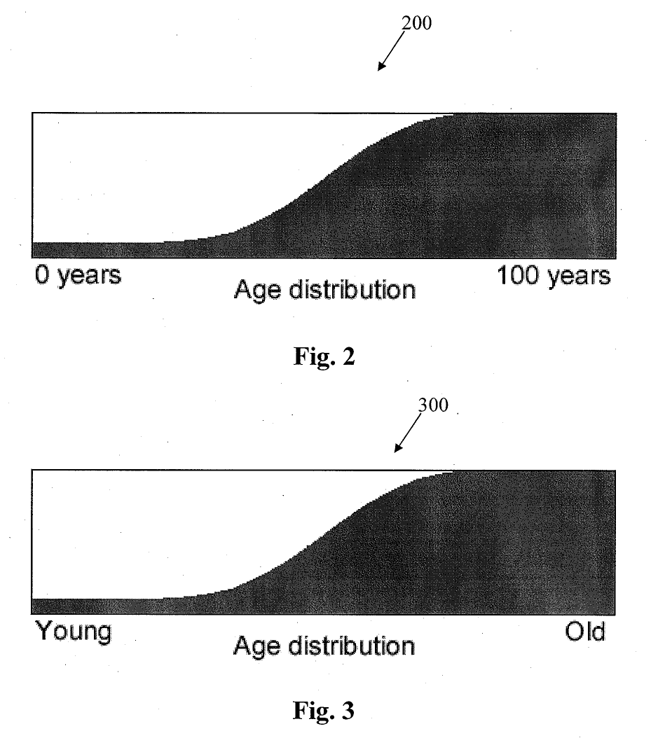

A method of automatically targeting suitable offer selections to specific recipients or groups of recipients is based on the use of “distributions.” These distributions are similar to probability distributions in mathematics, but they do not necessarily represent probabilities. They may represent expectations or intentions on the part of an advertiser, publisher or recipient user. As an example, one may consider the concept of “age,” which can be measured quantitatively on a scale from zero to 100 years, as in FIG. 2, which shows the dependent variable being a sigmoid-shaped increasing function 200 of the “age” independent variable.

Age may also be expressed qualitatively on a scale from “young” to “old.” While empirical data, such as that from surveys or focus groups that shows the exact distribution of purchasers of a given product or users of a given web site in terms of their ages, is occasionally available for use in marketing campaigns, it is rare. However, a qualitative understanding of the age distribution of the users of a web site is not difficult to acquire. Similarly, a qualitative understanding of an advertiser's expected target market age distribution is also not hard to acquire.

FIG. 3 shows a curve 300 that illustrates a qualitative age distribution. Such qualitative distributions can easily be expressed by an advertiser who can simply express the thought “this product is intended for young people,” or as is the case in FIG. 3, “this product is intended for adults, and is more applicable as you get older.”

Distributions can be used to express a wide variety of variables. Conventionally, advertising markets are segmented according to a set of quantitative variables, since these are what can be determined empirically according to consumer surveys, although at great cost. The present method is entirely compatible with such quantitative variables but it can also be applied to other variables that may be hard or impractical to measure but for which the parties involved have an intuitive understanding, for example, gender. A qualitative distribution curve such as that shown in FIG. 3 allows the use of variables and scales such as “masculine to feminine;” in other words, a gender identity-based scale, as opposed to a simple binary sex identification of male/female. Such a scale allows concepts such as “very masculine” or “gender neutral” to be captured and expressed in developing and implementing marketing strategies.

Similarly, variables such as “young to old” as above, “rich to poor,” “highly-educated to minimally-educated,” “image-insensitive to image-conscious,” “rural to metropolitan” can be readily expressed as qualitative variables, even in the absence of supporting empirical data. Although the above description has discussed distributions over single independent variables, it is to be appreciated that the same approach can be applied without loss of generality to distributions involving multiple independent variables. The use of single independent variables has some benefit in terms of convenience of implementation and data capture for the distributions, but is not required. For example, a three-dimensional distribution can be established, whose independent variables are (say) “young to old” and “rich to poor.” The dependent variable of this distribution reflects the combination of the two input variables.

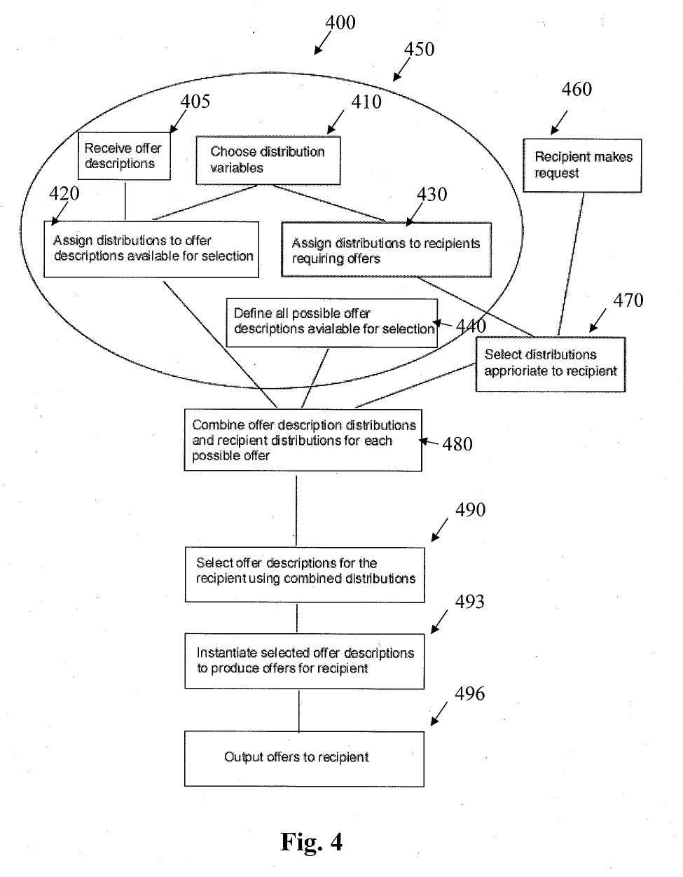

FIG. 4 shows a flow diagram of a method 400 for automatically targeting offer selections using distributions. In overview, the method 400 starts with the receipt of offer descriptions from the provider(s) 405. Next, the distribution variables are selected 410. As an example, these might be variables for such concepts as young-to-old, and poor-to-rich. Many other demographic and behavioral variables, for example, lend themselves to qualitative expression, such as tall/short, active/sedentary. Additionally, tastes, skills, traits, interests, political orientation and lifestyle preferences, such as musical/non-musical, vegan/meat-eater all lend themselves to expression as qualitative distributions.

Selected distribution variables are assigned to the offer descriptions available for selection 420. Within the present context, the offer descriptions may be, for example, product line items in a catalog and assignment of variables may be based, for example on brand, product category or explicitly for each offer description. Additionally, it is to be appreciated that distribution variables could be assigned at each level: brand, category and offer description.

After distribution variables are assigned to offers, the chosen distributions 410 are also used to assign distributions to recipients 430. In the present context, recipients may be visitors to web sites, and so the assignment may be to specific web pages, sets of web pages, or to specific users.

Next, the set of possible offer descriptions available for selection is defined 440. As with the selection of the distribution variables 410, the selection in step 440 is exogenous to the process. The steps shown in the oval 450, namely 405, 410, 420, 430, and 440 are typically performed by a system administrator, and are typically performed off-line. In other words, they may be performed only once before the process is made available to the recipients.

When process 400 is made available to recipients, requests are made to the system in step 460. The request originating from the recipient 460 is used in step 470 along with the recipient distribution assignments 430 to select, in real time, distributions appropriate to the recipient. For example, if a request is made from the web page http://acme.blog/health/, then step 470 may select the distributions for http://acme.blog/ as being the set of distributions that have been defined closest to the URL for the request. In another embodiment, distributions may be selected from a number of different web pages up the site map hierarchy, so as to define distributions for all of the variables defined in step 410. The distributions selected in step 470 for the recipient and the distributions assigned to the offer selections in step 420 may be combined for each of the offer selections available for selection 440 in step 480. This may be done by aggregating the assigned offer description distributions and the recipient distributions. This results in a ranking for each of the offer selections. Offer descriptions are selected using the combined distributions 490. Once offer descriptions have been selected 490, the offer descriptions are instantiated with respect to the recipient's request 493. Finally, the instantiated offers are output to the recipient 496.

In one embodiment, a roulette wheel selection mechanism, also known as fitness proportionate selection, may be used to select offer descriptions. Additionally, the selection step may be performed using a selection mechanism such as simple ordering, wherein the highest-ranking n objects are selected. Other selection devices may be used and are within the scope of the claimed subject matter. There follows herein below a more detailed description of the foregoing method of targeting offer selections based on distributions.

The first step in the process is the receipt of offer descriptions. Offer descriptions can be received in a wide variety of forms, depending on the particular implementation substrate for the present invention. Catalogs containing offer descriptions for products will often come from providers as spreadsheets with columns identifying the product name, description, price etc. Simpler offer descriptions may consist only of a directory of banner images. Those skilled in the art will understand that some preprocessing of offer description content may be required to make it compatible with the present invention.

As above, the variables on which the process operates are chosen. This choice is domain-specific, depending on the application to which the process is to be put. In the field of advertising, a useful set of variables to consider might be: “Young to old,” “Masculine to feminine,” “Rich to poor,” “Well educated to poorly educated,” “Image-conscious to not-image-conscious” and “rural to metropolitan.” The foregoing selection is, however, merely illustrative. The variables selected are picked for their relevance to the domain under consideration. In the case of advertising, these variables are linked to buying habits. By contrast, a variable such as “Preference of apples over bananas” is meaningful, but even if such a variable were to be expressed, there would be few domains outside fruit purchase that are likely to find this variable predictive of any interesting user behavior.

The next step in the process is to assign distributions to these variables for the offer descriptions available—in the case of advertising, to products, services, media content, classified advertisements or other offers. These variables may be assigned to relevant aspects, or characteristics of the products in question. There is no restriction on the method of selecting these relevant aspects, or characteristics, but any given problem domain will easily suggest them. In the case of product advertising, the brand or manufacturer of the product is universally considered to be important, as is the category of the product within a taxonomy of products, it is often fruitful to assign distributions to these concepts. Distributions may be quantitatively established using empirical data, perhaps from market surveys. Distributions may be assigned to the known brands and to known categories. For example, even if nothing quantitative is known about the sales figures of Acme, a brand of lawnmowers, simply from an understanding of common norms of society, expectations can be expressed in the target variables about who is most likely to buy these lawnmowers, thereby qualitatively establishing a distribution. For example, these expectations may be expressed as below, with the associated variables shown in parentheses:
Men (masculine to feminine scale—this is a societal norm);
Mostly by middle aged people (young to old scale—young people rent houses, and so don't mow their lawns, old people already own lawnmowers);
Middle to upper income (rich to poor scale—one generally has to be moderately wealthy to own a house);
Flat distribution for education (well-educated to poorly-educated scale—there is no reason to believe that education has anything to do with selecting this brand);
Flat distribution for image (image-conscious to not-image-conscious scale—there is no reason to think that this is a big image brand, unlike, for example, Gucci); and
Skewed towards rural and suburban (rural to metropolitan scale—people in the middle of the city rarely have lawns).

Similar analyses can be performed for any taxonomic category, such as “women's dress shoes,” for example:
Women (masculine to feminine);
Adults, tailing off with increasing age (young to old);
Middle to upper income (rich to poor);
Flat distribution for education (well-educated to poorly-educated);
Highly image conscious (image-conscious to not-image-conscious); and
Skewed towards suburban and metropolitan (rural to metropolitan).

From the foregoing analysis, it is evident that not all variables have utility for all brands or categories. The goal is simply to capture whatever can be reasonably deduced about the category or offer description. It is the capturing of the preferences and expectations that enables automatic targeting of suitable offers to a target audience. Thus, the system can typically deduce enough about offers being made and the users to whom they are to be made not to display women's dress shoes to readers of a farm machinery web site, for example.

Finally, it is also possible to establish distributions for particular offers in the population of offer descriptions. That is, in this example, specific distributions can be assigned to individual offer descriptions. As a general matter, as the number of offer descriptions increases, the task of assigning specific distributions to individual offer descriptions becomes more challenging. Nevertheless, doing so explicitly for important top-selling products allows a more accurate representation of those particular offerings. This is most important if, for example, a given merchant or brand has an outlier product, such as a single handbag being offered by a shoe brand, or a digital audio player being offered by a desktop computer brand.

The distributions having been assigned to the offer descriptions available for selection, the products in the catalog, for example, according to the selected aspects, or characteristics of the offer descriptions, brand and category, for example, a similar assignment may be made to the recipient side. That is, for exactly the same set of variables, distributions are categorized for the publisher's site. The exact identity of the recipient is not always known and so, distributions may be assigned to publishers or user groups as well as users. Here, we can think of these recipients' distributions as representing the intentions of the recipient. For example, one may consider a web site for a newspaper. In general, a newspaper publisher can be expected to have a good understanding of the average visitor to its web site, for example:
Somewhat biased to men (masculine to feminine);
Adults, tailing off with increasing age (young to old);
Middle to upper income (rich to poor);
Middle to high education level (well-educated to poorly-educated);
Flat distribution (image-conscious to not-image-conscious); and
Flat distribution (rural to metropolitan).

The above distributions capture the publisher's expectation of someone visiting the web site in the absence of any other information. However, a user's path through the pages of the newspaper's site can reveal additional demographic and/or psychographic data about the user, for example, age and degree of image-consciousness. Thus, if the user clicks on the “Sports” link from the newspaper's home page, a new set of distributions might be appropriate:
Mostly men (masculine to feminine);
Adults, tailing off with increasing age (young to old);
Low to middle income (rich to poor);
Flat distribution (well-educated to poorly-educated);
Flat distribution (Image-conscious to not-image-conscious); and
Flat distribution (rural to metropolitan).

Such distributions would make it more likely that products such as team-branded sweatshirts might be advertised to a sports reader. Similarly, the user clicking on the “Health” link may hint that the user is more likely to be a woman, and the system would be more likely to show shampoo and shoes.

While distributions can be associated with a publisher's site map, distributions can also be associated with individual users. While demographic and psychographic profiles are not readily available on the web for individual users, in some applications such as blog (web log) sites and community sites, detailed user profiles can provide a wealth of information that may allow the automatic assignment of distributions to users. Similarly, logging information about the browsing behavior of users can facilitate the deduction of profiles for the user in terms of the distributions described herein.

The steps elaborated above result in there being a collection of distributions that describe the expectations and intentions of the provider with respect to the offer descriptions available for selection, expressed according to a number of different measures. In the present example, distributions are supplied for such measures as “young to old” for both the brand and the category of the product to be advertised. Similarly, there are multiple distributions describing consumers of the advertisements, coming from the publisher and/or end users. For reasons of computational convenience it may be useful at this point to aggregate the distributions from the provider and the distributions from the consumer so as to reduce the set of distributions for each dimension into a single distribution. The ordinarily-skilled practitioner will understand that this aggregation can be performed using a number of different mathematical operations. In the preferred embodiment, these distributions are aggregated by means of normalized multiplication of the curves. First, the curves are multiplied together. After the multiplication, the resulting curve is normalized so that all distributions being considered have values in some convenient range, such as zero to one. A similar normalized multiplication may be performed in the combining step.

In practice, distributions may be implemented in a number of different ways. For example, they may be represented using mathematical functions that fully define the distribution analytically, e.g. a normal distribution with a particular mean and standard deviation. Distributions may also be defined in a piecewise fashion as an ordered set of points on the curve (or hyperplane) of the distribution. If the distributions are represented using mathematical functions, then the aggregation or combining steps may well be most conveniently implemented by computing a mathematical function as the closed form solution to the aggregation of the distributions. If the distributions are represented numerically, then a piecewise numerical aggregation or combining operation will typically be a better implementation. The determination of such closed form solutions or the performing of such numerical aggregations is well understood by those skilled in the art.

In one embodiment, distributions may be elicited from users, whether for providers or consumers, by means of a graphical user interface (GUI), which depicts the distributions as graphs. A library of predefined distributions may be provided so as to allow the user to select common distributions.

Thus, by assigning a product to a product category, the product automatically may be assigned any distributions that have been or will be assigned to its category. Additionally, the product may automatically receive any distributions that have been or will be assigned to its brand. In addition to, or instead of these category and brand distributions, distributions may be configured and applied directly to the individual products in certain circumstances.

When empirical data are available for any of the variables being considered, distributions may be defined programmatically in whole or in part by analytically or numerically converting the empirical data into appropriate distributions or biases to distributions. Such empirical data may, for example, reflect the performance of certain products in the marketplace, but it is to be appreciated that any empirical data related to any of the variables considered by the system may be used in this manner.

Distributions may also be derived through analysis of a user's actions. This is particularly significant in the case of search terms expressed by a user. For example, if a user enters a keyword search expression, such as “pink blouse,” then an analysis of these words can be used to specify distributions that reflect the user's intent. In this case, the word “blouse” may be mapped into a taxonomic reference to a product category, such as “blouses.” The distributions already defined for offer selections on the basis of the categories to which they belong may be used in a manner analogous to that described above. Equally, the adjective “pink” may be used to suggest values for distributions, perhaps on the masculine-to-feminine scale. A dictionary of commonly-used words and distributions for these words may be predefined to cover important cases of user searches.

This technique is not limited to keyword queries such as those frequently used for Internet search engines. Taxonomic queries, in which values for specific categories are selected and parametric queries parameters, in which values for specific attributes are selected, may also be used to drive the selection and assignment of distributions. In the case of parametric search, the user may apply constraints to one or more attributes of the offers being sought. For example, the user might select “Pink” from the “Color” menu when searching for, say, a car. Again, this user input may be used to suggest a value for a distribution. In the case of parametric queries, the set of available attributes and the possible values that these attributes might take on may be mapped into distributions. Taxonomic search is handled in an analogous manner. The user's selection of a particular category may be mapped into distributions by mapping the user's category into a category known to have associated distributions.

The particular details of keyword, taxonomic and parametric search may vary from system to system, but it is to be appreciated that the methods and systems herein described may readily address any of these search techniques or a combination of these search techniques.

It should also be recognized that the expression “user” (recipient) does not necessarily denote a human user. Keyword, taxonomic, and parametric searches may be handled by the current system whether they are initiated by human users, or by computational processes.

The aggregation operations for the advertiser data may usually be pre-computed and cached. Similarly, in some circumstances the analogous caching can be performed for the recipient's distributions. These pre-computations and caching operations will generally dramatically reduce the amount of run-time computation. In certain circumstances, it may even be possible to pre-compute and cache all possible combined distributions, in which case a substantial performance improvement is possible.

It is often the case that the number of possible distributions can be limited to a small set of predefined distributions. If this is so, then all combinations of distributions can be pre-computed and the aggregated distributions can be stored in a lookup table. The same process may be performed for the combining step.

The next step is to combine the publisher and user distributions with the distributions for the applicable advertiser's offer descriptions, which may also have been aggregated. Many possible combining functions or algorithms are possible. In one embodiment, the combination is accomplished by multiplying the distributions and integrating the resulting distribution, resulting in a scalar value for each combined set of distributions, i.e., for each offer description. This same integrating and multiplying process may be applied to the aggregating step. Another possible embodiment of the combining operation is a distance minimizing computation such as a generalized n-way Least Squares computation that calculates the similarity between n distributions.

Just as it is possible to cache aggregated distributions, combined distributions can similarly be cached and, when the identity of the distributions can be established as being in a well-defined set, then a lookup table can store pre-computed combined distributions.

The next step is to select the desired set of offer descriptions. A simple way to perform this selection (which we will call “simple ordering”) is to sum the combined distribution values across all of the variables for every offer description. We call this sum the “rank value” of the offer description. Next, the combined distribution values from the recipient are summed to produce the recipient's rank value. Finally a subset of the available offer descriptions is chosen, equal in size to the number of offer descriptions requested by the recipient. Those offer descriptions that are selected, as described above, are those whose rank value is the closest to the recipient's rank value. This simple ordering procedure may or may not be deterministic, depending how the ranked offers are searched. That is, for a given rank value, some implementations may not always return the exact same set of selections.

Those skilled in the art will understand that this summation step can be implemented by many mathematical or algorithmic means, such as addition or normalized addition. In one embodiment, the summation is weighted by the relative importance attached to the different distribution variables.

Even if the simple ordering procedure is non-deterministic, it does not generally result in a significant variety of offer descriptions selected, unless there are many offer descriptions that share the same rank value and that could potentially be selected. Thus, a simple ordering selection mechanism is a good strategy when variety is considered to be unimportant and when the best-known matches are always preferred.

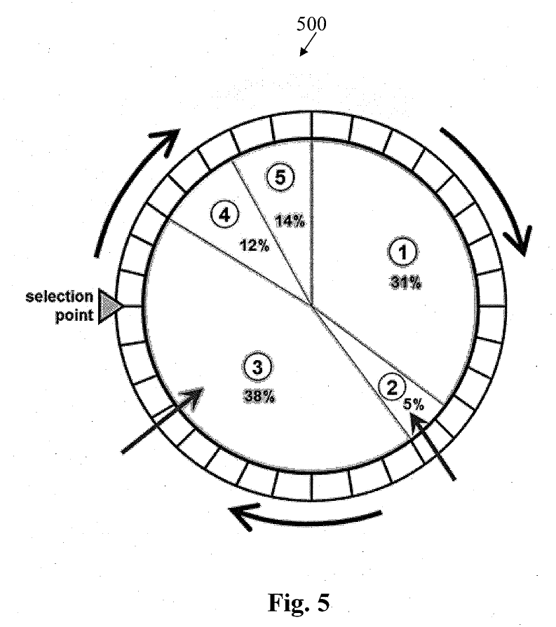

In many circumstances, however, a publisher may require more variety in the returned set of offer description selections. The inevitable imprecision in the ranking of the offers means that there is substantial uncertainty as to the global optimality of any given selection. Thus, it is generally desirable to make selections that sample a wide variety of credible selections, but in a manner that reflects the expected quality of the selections in a reasonable way. To achieve this, one embodiment uses a biased roulette wheel mechanism. In this procedure, a virtual roulette wheel 500, shown in FIG. 5 is created around whose periphery are located the offer descriptions. The angles subtended by the offer descriptions at the center of the roulette wheel are inversely proportional to the absolute difference between the offer rank value and the recipient rank value. Thus, as shown in FIG. 5, those offer descriptions that are most compatible with the recipient's profile are allotted a larger portion of the periphery of the wheel. Random numbers are then computed so as to select an angle around the circle of the roulette wheel. Those offer descriptions whose subtended angles embrace the angles specified by the random numbers are selected. Using a roulette-wheel selection mechanism, every offer description has a non-zero probability of being selected but those offer descriptions with high rank values have a correspondingly higher probability of being selected because they occupy a greater portion of the periphery of the wheel. As shown in FIG. 5, offer description #3 occupies a portion of the roulette wheel such that there is 38% probability that offer description #3 will be selected on any turn of the wheel. Likewise, offer description #2, being least compatible, occupies a portion of the wheel such that there is only a five percent probability of being selected on any turn of the wheel. A limitation may be placed on the selection mechanism to prevent a given offer description from being selected more than once.

Many factors can be taken into account when setting up the roulette wheel for such selections. One important factor to take into account is real world data feedback. In one embodiment, logging information from the use of the system is fed back into the system so as to bias the roulette wheel. For example, real world sales conversion statistics concerning the offer descriptions being selected can be normalized and combined with the rank values in order to increase the probability that offer descriptions that are known to be more desirable are included in the selection. Another possible factor to be taken into account when setting up the roulette wheel is an a priori weighting of the distribution variables expressing the relative importance of those variables.

When offer descriptions have been selected by the present invention, they are instantiated into offers. In the simplest case, this is a trivial process of making, for example, a banner image available for output and distribution to the recipient of the request. However, in other cases the amount of processing necessary to instantiate an offer may be substantially greater, and those skilled in the art will understand that the processing required will be determined by the particular application required by the provider for the recipient. For example, the instantiation step may involve substituting any number of recipient- or publisher-specific elements into a template found in the offer description in order to make a fully-specified offer.

Finally, when the offers have been instantiated from the selected offer descriptions, the offers are output to the recipients. In the case of on-line advertising, this will typically take the form of responding to the recipient's (HTTP) request with a suitable advertisement tailored appropriately to the recipient. The distribution of offers to recipients using HTTP (Hyper Text Transport Protocol) is an example of offer distribution using the Internet. Those skilled in the art will understand that such distribution can extend to other distribution mechanisms. In this example, the recipients may be users of web sites. This outputting step may also distribute offers to recipients through electronic mail (email) or through RSS (Really Simple Syndication). In the case of direct marketing or free-standing insert campaigns, the output will be in the form of bulk mailings printed out and mailed.

In the foregoing specification, the invention has been described with reference to specific exemplary embodiments thereof. In particular, the application of the above system and method has been to the problem of targeted advertising in the online environment. The offer description being selected, however, need not necessarily be retail products to be advertised. They may, for example, be services, offers, coupons or even contact information about political candidates. Similarly, although the method and system have been described within the context of web site advertising, it is to be appreciated that the same practices can be applied to other forms of distribution such as electronic mail and direct, physical mail. In fact, the recipient may be a computerized agent, such as a bidding agent. Bidding agents may include an Advertising Exchange, an Advertising Network or an end-user software bot.

Just as there are many options to those skilled in the art for distribution channels for this outputting step, numerous modalities of receipt are available for the recipient. For example, the recipient may receive offers using Mobile Telecommunication Devices or Broadcast Media. Broadcast media may include Print media, Electronic media or Out of Home Advertising.

It will, therefore, be evident that various modifications and changes may be made to the foregoing methods and systems without departing from the broader spirit and scope of the invention as set forth in the appended claims. The specification and drawings are, accordingly, to be regarded in an illustrative sense rather than a restrictive sense.

1. A computer implemented process in which a selection of offer descriptions for a recipient is made using distributions, said process comprising the steps of:
receiving offer descriptions;
choosing distribution variables;
assigning distributions to the offer descriptions available for selection;
assigning distributions to the recipients requiring the offers to be selected;
combining said offer description distributions and said recipient distributions;
selecting said offer descriptions for the recipient using the combined offer description distributions and recipient distributions;
instantiating offers from said offer descriptions; and
outputting said offers to said recipient.

2. A process as in claim 1, wherein said offer descriptions represent products.

3. A process as in claim 1, wherein said offer descriptions represent services.

4. A process as in claim 1, wherein said offer descriptions represent media content.

5. A process as in claim 1, wherein said offer descriptions represent classified advertisements.

6. A process as in claim 1, wherein said offers are distributed using the Internet.

7. A process as in claim 6, wherein said recipients are users of web sites.

8. A process as in claim 6, wherein said recipients are users of email.

9. A process as in claim 6, wherein said recipients are users of RSS.

10. A process as in claim 1, wherein said recipients are users of mobile telecommunication devices.

11. A process as in claim 1, wherein said recipients are users of broadcast media.

12. A process as in claim 11, wherein said recipients are consumers of print media.

13. A process as in claim 11, wherein said recipients are consumers of electronic media.

14. A process as in claim 11, wherein said recipients are exposed to out of home advertising.

15. A process as in claim 1, wherein said recipients are computerized bidding agents.

16. A process as in claim 1, wherein said distributions are quantitatively established distributions.

17. A process as in claim 1, wherein said distributions are qualitatively established distributions.

18. A process as in claim 17, wherein said qualitatively established distributions express expectations.

19. A process as in claim 17, wherein said qualitatively established distributions express intentions.

20. A process as in claim 1, further comprising the step of:
aggregating said distributions.

21. A process as in claim 20, wherein said step of aggregating said distributions comprises the step of:
applying a normalized multiplication to aggregate said distributions.

22. A process as in claim 20, wherein said step of aggregating said distributions comprises the step of:
applying an integral of multiplication of curves to aggregate said distributions.

23. A process as in claim 20, wherein said step of aggregating said distributions comprises the step of:
applying a closed-form solution to aggregate said distributions.

24. A process as in claim 20, wherein said step of aggregating said distributions comprises the step of:
aggregating said distributions piecewise numerically.

25. A process as in claim 20, wherein said step of aggregating said distributions comprises the steps of:
pre-computing aggregations of said distributions; and
caching said pre-computed aggregations.

26. A process as in claim 20, wherein said step of aggregating said distributions comprises the step of:
using a lookup table to aggregate said distributions.

27. A process as in claim 1, wherein said step of combining said offer description distributions and said recipient distributions comprises the step of:
combining said offer description distributions and said recipient distributions via a normalized multiplication.

28. A process as in claim 1, wherein said step of combining said offer description distributions and said recipient distributions comprises the step of:
applying an integral of multiplication of curves to combine said distributions.

29. A process as in claim 1, wherein said step of combining said offer description distributions and said recipient distributions comprises the step of:
applying a distance-minimizing computation over n distributions to combine said distributions.

30. A process as in claim 1, wherein said distribution variables reflect demographic variables.

31. A process as in claim 1, wherein said distribution variables reflect psychographic variables.

32. A process as in claim 1, wherein said step of combining said offer description distributions and said recipient distributions comprises the step of:
applying a closed-form solution to combine said distributions.

33. A process as in claim 1, wherein said step of combining said offer description distributions and said recipient distributions comprises the step of:
combining said distributions piecewise numerically.

34. A process as in claim 1, wherein said step of combining said offer description distributions and said recipient distributions comprises the steps of:
pre-computing combinations of said distributions; and
caching said pre-computed aggregations.

35. A process as in claim 1, wherein said step of combining said offer description distributions and said recipient distributions comprises the step of:
using a lookup table to combine said distributions.

36. A process as in claim 1, wherein said step of selecting said offer descriptions comprises the step of:
using a simple ordering to select said offer descriptions.

37. A process as in claim 1, wherein said step of selecting said offer descriptions comprises the step of:
using a biased roulette wheel to select said offer descriptions.

38. A process as in claim 37, wherein the step of selecting said offer descriptions by applying a biased roulette wheel comprises the step of:
using real world data to bias the roulette wheel.

39. A process as in claim 1, wherein said step of assigning distributions to offer descriptions comprises the step of:
assigning distributions to brands.

40. A process as in claim 1, wherein said step of assigning distributions to offer descriptions comprises the step of:
assigning distributions to manufacturers.

41. A process as in claim 1, wherein said step of assigning distributions to offer descriptions comprises the step of:
assigning distributions to categories.

42. A process as in claim 1, wherein said step of assigning distributions to the recipients comprises the step of:
assigning distributions to publishers.

43. A process as in claim 1, wherein said step of assigning distributions to the recipients comprises the step of:
assigning distributions to users.

44. A process as in claim 1, wherein said step of assigning distributions to the recipients comprises the step of:
assigning distributions to user groups.

45. A process as in claim 1, further comprising the step of:
using a GUI to elicit distributions from a user.

46. A process as in claim 45, wherein said step of eliciting distributions from a user comprises the step of:
selecting said distributions by the user from a library of predefined distributions.

47. A process as in claim 1, further comprising the step of:
using empirical data to analytically or numerically influence said distributions.

48. A process as in claim 1, wherein said recipient distribution assigning step uses search parameters to define the distributions.

49. A process as in claim 48, wherein said search parameters comprise a keyword search.

50. A process as in claim 48, wherein said search parameters comprise a parametric search.

51. A process as in claim 48, wherein said search parameters comprise a taxonomic search.

52. An apparatus for selection of offer descriptions for a recipient using distributions, said apparatus comprising:
an input for receiving offer descriptions, choosing distribution variables, assigning distributions to the offer descriptions available for selection, and assigning distributions to said recipient requiring the offers to be selected;
a memory for storing said offer descriptions, said chosen distribution variables, and said assigned distributions;
at least one processor programmed for combining said offer description distributions and said recipient distributions;
said at least one processor programmed for selecting said offer descriptions for the recipient using the combined offer description distributions and recipient distributions;
said at least one processor programmed for instantiating offers from said offer descriptions; and
an output for outputting said offers to said recipient.

53. An apparatus as in claim 52, wherein said offer descriptions comprise products.

54. An apparatus as in claim 52, wherein said offer descriptions comprise services.

55. An apparatus as in claim 52, wherein said offer descriptions comprise media content.

56. An apparatus as in claim 52, wherein said offer descriptions comprise classified advertisements.

57. An apparatus as in claim 52, further comprising:
a mechanism for distributing via the Internet.

58. An apparatus as in claim 57, wherein said recipients comprise users of web sites.

59. An apparatus as in claim 57, wherein said recipients comprise users of email.

60. An apparatus as in claim 57, wherein said recipients comprise users of RSS.

61. An apparatus as in claim 52, wherein said recipients comprise users of mobile telecommunication devices.

62. An apparatus as in claim 52, wherein said recipients comprise users of broadcast media.

63. An apparatus as in claim 62, wherein said recipients comprise consumers of print media.

64. An apparatus as in claim 62, wherein said recipients comprise consumers of electronic media.

65. An apparatus as in claim 62, wherein said recipients comprise exposed to out of home advertising.

66. An apparatus as in claim 52, wherein said recipients comprise computerized bidding agents.

67. An apparatus as in claim 52, wherein said distributions comprise quantitatively established distributions.

68. An apparatus as in claim 52, wherein said distributions comprise qualitatively established distributions.

69. An apparatus as in claim 68, wherein said qualitatively established distributions express expectations.

70. An apparatus as in claim 68, wherein said qualitatively established distributions express intentions.

71. An apparatus as in claim 52:
said at least one processor programmed for aggregating said distributions.

72. An apparatus as in claim 71, wherein said at least one processor programmed for aggregating said distributions comprises a processor programmed for:
applying a normalized multiplication to aggregate said distributions.

73. An apparatus as in claim 71, wherein said processor programmed for aggregating said distributions comprises a processor programmed for:
applying an integral of multiplication of curves to aggregate said distributions.

74. An apparatus as in claim 71, wherein said processor programmed for aggregating said distributions comprises a processor programmed for:
applying a closed-form solution to aggregate said distributions.

75. An apparatus as in claim 71, wherein said processor programmed for aggregating said distributions comprises a processor programmed for:
aggregating said distributions piecewise numerically.

76. An apparatus as in claim 71, wherein said processor programmed for aggregating said distributions comprises a processor programmed:
for pre-computing aggregations of said distributions; and
for caching said pre-computed aggregations.

77. An apparatus as in claim 71, wherein said processor programmed for aggregating said distributions comprises a processor programmed for:
using a lookup table to aggregate said distributions.

78. An apparatus as in claim 52, wherein said processor programmed for combining said offer description distributions and said recipient distributions comprises a processor programmed for:
applying a normalized multiplication for combining said offer description distributions and said recipient distributions.

79. An apparatus as in claim 52, wherein said processor programmed for combining said offer description distributions and said recipient distributions comprises a processor programmed for:
applying an integral of multiplication of curves to combine said distributions.

80. An apparatus as in claim 52, wherein said processor programmed for combining said offer description distributions and said recipient distributions comprises a processor programmed for:
applying distance-minimizing computation over n distributions to combine said distributions.

81. An apparatus as in claim 52, wherein said distribution variables reflect demographic variables.

82. An apparatus as in claim 52, wherein said distribution variables reflect psychographic variables.

83. An apparatus as in claim 52, wherein said processor programmed for combining said offer description distributions and said recipient distributions comprises a processor programmed for:
applying a closed-form solution to combine said distributions.

84. An apparatus as in claim 52, wherein said processor programmed for combining said offer description distributions and said recipient distributions comprises a processor programmed for:
combining said distributions piecewise numerically.

85. An apparatus as in claim 52, wherein said processor programmed for combining said offer description distributions and said recipient distributions comprises a processor programmed:
for pre-computing combinations of said distributions; and
for caching said pre-computed aggregations.

86. An apparatus as in claim 52, wherein said processor programmed for combining said offer description distributions and said recipient distributions comprises a processor programmed for:
using a lookup table to combine said distributions.

87. An apparatus as in claim 52, wherein said processor programmed for selecting said offer descriptions comprises a processor programmed for:
applying a simple ordering to select said offer descriptions.

88. An apparatus as in claim 52, wherein said wherein said processor programmed for selecting said offer descriptions comprises a processor programmed for:
applying a biased roulette wheel to select said offer descriptions.

89. An apparatus as in claim 88, wherein said processor programmed for selecting said offer descriptions by applying a biased roulette wheel is programmed for:
using real world data to bias the roulette wheel.

90. An apparatus as in claim 52, wherein said wherein said processor programmed for assigning distributions to offer descriptions is programmed for:
assigning distributions to brands.

91. An apparatus as in claim 52, wherein said wherein said processor programmed for assigning distributions to offer descriptions is programmed for:
assigning distributions to manufacturers.

92. An apparatus as in claim 52, wherein said wherein said processor programmed for assigning distributions to offer descriptions is programmed for assigning distributions to categories.

93. An apparatus as in claim 52, wherein said processor programmed for assigning distributions to the recipients is programmed for:
assigning distributions to publishers.

94. An apparatus as in claim 52, wherein said processor programmed for assigning distributions to the recipients is programmed for:
assigning distributions to users.

95. An apparatus as in claim 52, wherein said processor programmed for assigning distributions to the recipients is programmed for:
assigning distributions to user groups.

96. An apparatus as in claim 52, said at least one processor programmed for eliciting distributions from:
step for providing a GUI.

97. An apparatus as in claim 96, wherein said processor programmed for eliciting distributions from a user comprises a processor programmed for:
user selection of said distributions from a library of predefined distributions.

98. An apparatus as in claim 52, further comprising a processor programmed for:
using empirical data to analytically or numerically influence said distributions.

99. An apparatus as in claim 52, wherein said processor programmed for assigning distributions to said recipient is programmed for:
assigning said recipient distribution based on entered search parameters.

100. An apparatus as in claim 99, wherein said search parameters comprise a keyword search.

101. An apparatus as in claim 99, wherein said search parameters comprise a parametric search.

102. An apparatus as in claim 99, wherein said search parameters comprise a taxonomic search.

103. A computer readable storage medium comprising program instructions stored therein for executing the steps of claim 1.
